(19) United States
(12) Patent Application Publication
(10) Pub. No.: US 2003/0015437 A1
(43) Pub. Date: Jan. 23, 2003

(54) Method for in-situ analysis and flow cell therefor

(75) Inventors: George W. Luther, Rehoboth Beach, DE (US); Douglas C. Hicks, Rehoboth Beach, DE (US)

Correspondence Address: Paul E. Crawford, Connolly Bove Lodge & Hutz LLP, P.O. Box 2207, Wilmington, DE, 19899, US

(73) Assignee: University of Delaware

(21) Appl. No.: 10/180,162

(22) Filed: Jun. 25, 2002

Related U.S. Application Data
(60) Provisional application No. 60/303,849, filed on Jul. 9, 2001.

(51) Int. Cl. G01N 27/417

(52) U.S. Cl. 205/775; 204/410

(57) ABSTRACT

A voltametric flow cell for measuring chemical species having improved reliability and accuracy under the high pressure conditions of deep sea water is disclosed. The cell has a three electrode arrangement positioned in a durable polymer for measurement of a wide variety of redox chemicals and ions.

### RELATED FEDERALLY SPONSORED RESEARCH

The work described in this application was sponsored by the National Oceanic and Atmospheric Administration, Office of Sea Grant, Contract No. 96RG0029.

### BACKGROUND OF THE INVENTION

1. Field of the Invention

This invention relates generally to geochemistry, particularly, to electrochemical methods for analysis and a voltammetric flow cell to detect and measure chemical species in both laboratory and field conditions. The invention has proven to be reliable and accurate under a range of field conditions, including high pressure conditions. The instant method is based on a dependence of current vs. concentration standard curves and has particular use for simultaneous measurement in situ of electroactive species in field samples.

The voltammetric flow cell has a three-electrode arrangement, wherein Au/Hg amalgam solid-state working electrodes are used in combination with reference and counterelectrodes in a closed-system voltammetric cell made from the durable polymer for the measurement of a wide variety of redox chemicals and ions.

2. Description of Related Art

A method to detect concentration of the electroactive species in a laminar flow is based on the known Levich equation

I=knFCD^{2/3}r^{3/2}U^{1/2}v^{1/6}

where I represents current under mass-transport controlled conditions, k is a constant coefficient, n is the number of electrons transferred, F is the Faradey constant, C is the concentration of the electroactive species, D is the diffusion constant, r is the radius of a disk-shaped but stationary electrode, U is the rate of flow through the cell, and v is the kinematic viscosity.

Quantitative measurements of chemical species may be obtained by measuring current at different potentials from an electrochemical cell with specially selected electrodes. See, for example, Brendel, P. “Luther III, G. W., Environ. Sci. Technol. 1995, 29, 751-761.

The incorporation of microelectrodes into continuous flow detectors is known, and electrochemical flow-cells designed for use under atmospheric pressure have been available for some time. Such cells permit minute quantities of a large number of samples to be rapidly evaluated under identical conditions. Furthermore, they reduce errors due to contamination and handling and provide opportunities for computerized autosampling, pre-analysis conditioning, and data collection. Mahoney L.; O'Dea, J.; Osteryoung, J.; Anal. Chim. Acta 1993, as reported in 281, 25-33, and Bjorefors, F.; Nyholm, L. Anal.Chim.Acta 1996,325, 11-24. Another advantage of flow cells in natural settings is that samples are processed immediately and thereby minimize the effects of degassing, oxidation, and microbial metabolism associated with sample storage.

However, in oceanography, where measurements are very often made at great depths, and high pressure, conventional flow cells have proved inadequate. For example, flow cells using hanging mercury drop electrodes (HMDE) are bulky and do not work at high pressure. In situ analysis is difficult, if not impossible as reported in De Vitre, R. R.; Buffle, J.; Perret, D.; Baudat, R. Geochim Cosmochim Acta, 1988. 52, 1601-1613.

Other flow cell designs have proved deficient because they require significant pre-analysis handling of the sample, including filtration, purging or degassing, and various pre-concentration and chelation steps to determine low levels of trace metals as reported in De Vitre, R. R.; Buffle, J.; Perret, D.; Baudat, R. Geochim Cosmochim Acta, 1988. 52, 1601-1613; Liberman, S. H.; Zirino, A. Anal. Chem. 1974, 46, 20-23; Martinotti, W.; Queirazza, G.; Realini, F.; Ciceri, G. Anal. Chim. Acta 1992, 261, 323-334; Newton, M. P.; van den Berg, C. M. G. Anal Chim. Acta 1987, 199, 59-76. Other closed flow cells using a mercury film on a 3 mm glassy carbon electrode have been used as reported in Tercier, M-L.; Buffle, J; Zirino, A.; De Vitre, R. R. Anal. Chim Acta 1990, 237, 429-437. Such cells are not totally free from sample pre-treatment requirements and are only available for operation in situ under low pressure conditions (only 2 atmospheres or 20 meters) water depth). In addition, these cells are too specialized, complicated and expensive for most applications.

Accordingly, an object of the present invention is to provide a portable, rugged, cheap, reliable and easy to handle closed-system voltammetric cell for measuring in situ, with a high degree of precision and accuracy, the redox-sensitive species as O₂, Mn(II), Fe(II), S₂O₃²⁻, I⁻, and S(−II) at elevated pressures, temperatures and flow rates in natural waters.

### SUMMARY OF THE INVENTION

In a preferred embodiment of this invention, gold/mercury amalgam electrodes are used as working electrodes in a flow cell of closed type described in more detail below. This cell functions independently of internal or external pressure. In the laboratory, internal pressure is applied with the flow-cell between a high pressure liquid chromatography (HPLC) pump and a HPLC column for back pressure. The gold/mercury amalgam electrode can be calibrated for deep sea and hydrothermal vent conditions and, being a solid-state electrode, permits simultaneous in situ analysis of a wide range of aqueous dissolved species in both field and laboratory settings at pressures from atmospheric up to at least 250 atmospheres and temperatures ranges of from about 2 to 150° C. and at flow rates from zero to 12 ml per minute. No other flow cell has been made for work above 2 atmospheres and 25° C.

The flow cell is preferably made of an inert polymer such as PEEK™ (polyethyletherketone). Other suitable inert polymers are polyethylene (PE), polypropylene, polytetraflouroethylene (PTFE), polyether imide, polyvinylidene fluoride (PVDF) and like polymers that are stable at high temperature, are non-conductive and relatively inert (do not leach chemicals that could interfere with analysis). The flow cell has a shape of a cylinder, wherein a hole is drilled along its length to form ports at each end for sample input-output. Multiple holes are formed in the cell perpendicular to the lengthwise hole for multiple, preferably three, solid-state electrodes. The system preferably utilizes a reference (Ag/AgCl or Pt) electrode, a Pt counter electrode and an Au/Hg amalgam-working electrode. The electrodes are set in the cell so that flow is not impeded.

The flow cell is a completely closed system, constructed from PEEK or other inert material, wherein standard HPLC fittings (0.125 inch) are used, which permit the rapid removal or exchange of electrodes and sample tubing, and the use of the cell at elevated temperature and pressures.

The use of the cell permits benchtop work on sub-micromolar to millimolar level analyses to be performed quickly and without any sample manipulation or exposure to atmospheric conditions, and, additionally, the electrodes may be deployed over considerable water depths without special calibration.

PEEK electrodes are robust and can be successfully deployed from a remotely operated vehicle directly into near-shore sediments to the waters of the deep sea.

### BRIEF DESCRIPTION OF THE DRAWINGS

The accompanying drawings illustrate the invention. In such drawings:

FIG. 1A is a left-end elevational view of the flow cell without electrodes in place;

FIG. 1B is a cross-sectional view in elevation taken along line 1B-1B of FIG. 1A.

FIG. 2A is a schematic of the flow cell and electrodes used therein;

FIG. 2B is a side elevational view of the electrode used in this invention;

FIG. 3 are charts illustrating the current response of the electrodes in the flow cell under different flow and pressure conditions. The reduction of Mₙ²⁺ to Mₙ^{O} was measured.

FIG. 4 are charts illustrating a plot of flow rates versus sensitivity ratios (R).

FIG. 5 are charts, illustrating representative voltammograms using the flow cell of this invention.

FIG. 6 is a chart sulfide determined in the flow cell at 2500 meter water depth from a submersible versus the sulfide determined aboard ship.

### DETAILED DESCRIPTION OF THE PREFERRED EMBODIMENT

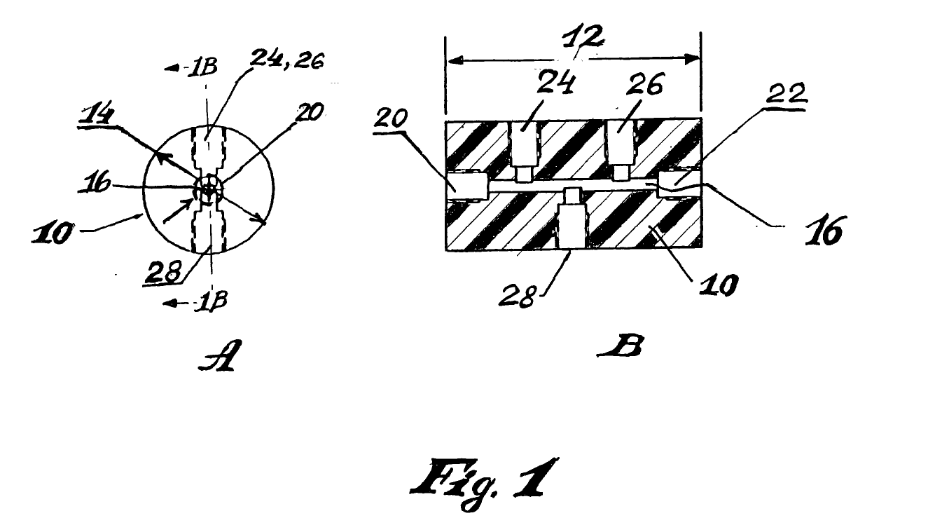

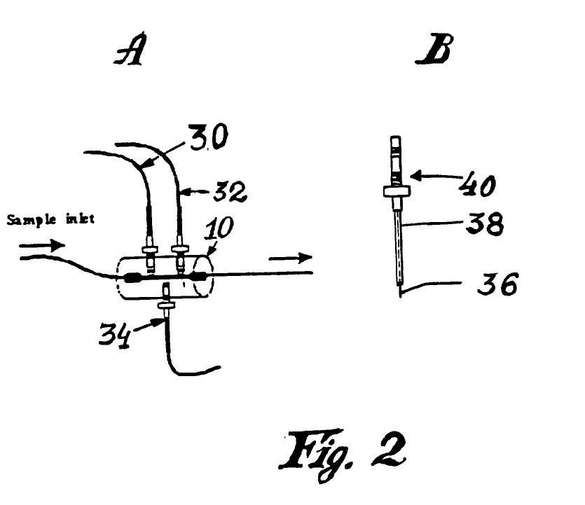

In a preferred embodiment of this invention (FIGS. 1 and 2), the flow cell 10 is approximately 2 inches in length 12 and 1 inch in diameter 14. A hole 16 of about 0.0625 inch (1.59 mm) diameter is drilled along its length with ports at each end for sample input 20 and output 22. Three holes 24, 26, 28 are drilled perpendicular to the lengthwise hole for a three solid-state electrode system. The size of the cell can be adjusted depending on the volume of material to be analyzed.

The reference electrode 30 is typically a 500 μm Ag/AgCl or Pt electrode, the counter electrode 32 is typically a 500 μm Pt electrode and the working electrode 34 is a 100 μm Au/Hg electrode.

A gold/mercury amalgam electrode can be made by fixing 100 μm-diameter gold wire soldered to the conductor wire of BNC cable 36 within a body of 0.125″-diameter PEEK™ or similar tubing 38, which is commercially available as standard HPLC high-pressure tubing. The metal is fixed within the tubing with the West System 105 epoxy resin and 206 hardener. A portion of the black outer coat and braid of the BNC wire are removed to expose the Teflon shield and Cu conductor wire so that the Au wire soldered into the Cu conductor can be inserted in the PEEK™ tubing. The epoxy is injected into the PEEK™ tubing which contains the gold wire that was previously soldered to the conductor wire of the BNC cable. Then the Teflon is inserted into the PEEK™ tubing until the black coating of the BNC wire fits against the PEEK™ tubing, and the assembly is held so that epoxy, which has a moderate setting time (approximately, 1 hour), does not drain out the lower open side. On setting, the epoxy seals the tip and the top end can be refilled with epoxy if necessary. Then the top end is coated with Scotchkote (3M) electrical coating and Scotchfil (3M) electrical insulation putty. Pt counter and solid Ag/AgCl reference electrodes were made similarly but 500 μm diameter wire was used for each and inserted into PEEK tubing. These electrodes are mated with standard HPLC threaded fittings 40 from, for example, Upchurch, Inc. for insertion into corresponding threated openings in the flow cell 10.

Once constructed, the working electrode (Au) surface is sanded, polished and plated with Hg by reducing Hg(II) from a 0.1 N Hg/0.05 N HNO₃ solution, for 4 minutes at a potential of −0.1 V, while purging with N₂. The mercury/gold amalgam interface was conditioned using a 90-second −9 V polarization procedure in a 1 N NaOH solution as more fully described in Brendel, P.; Luther, III, G. W., Environ. Sci. Technol. 1995, 29, 751-761. The electrode was then run in linear sweep mode from −0.05 to −1.8 V versus a Saturated Calomel Electrode (SCE) of Ag/AgCl electrode several times in oxygenated sea water to obtain a reproducible O₂ signal.

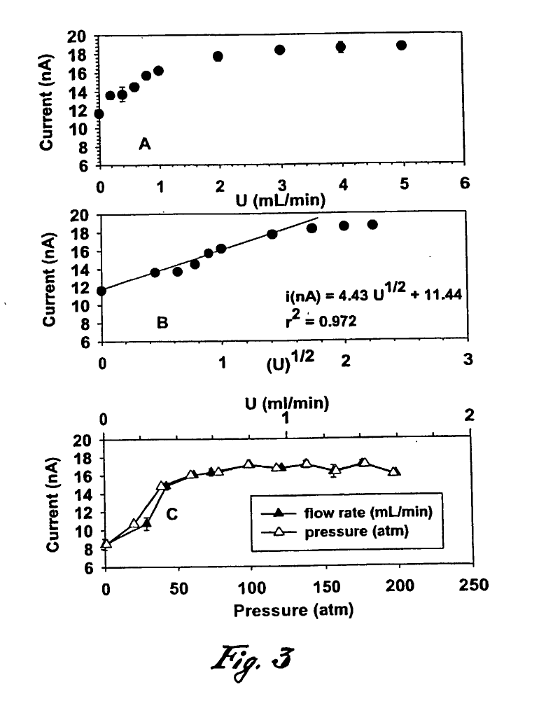

Laboratory experiments confirm that the flow cell works under variable flow and high pressure. Chart A of FIG. 3 graphically illustrates the current response of a 150 micromolar concentration of manganese (II) solution with flow rate at atmospheric pressure and a voltage scan rate of 200 mV per second. Chart B of FIG. 3 shows that the current response is linear with the square root of the flow rate until 2 ml per minute. Above that velocity, the response is constant due to the small diameter of the working electrode. Chart C of FIG. 3 shows that the current change follows the flow rate when the induced pressure is varied (the flow cell is between a HPLC pump and a HPLC column to induce pressure). These data confirm that current response is independent of pressure and that the flow cell is ideal for high pressure applications.

In an embodiment of this invention, particularly adapted for Deep Sea research, three working electrodes should be placed into the flow cell. The reference electrode 30 is preferably solid state Ag/AgCl, and the counter electrode 32 is Pt wire, both of which were mounted on the basket of a deep sea vehicle (DSV) so that they would not enter sulfidic waters. For hydrothermal vent work, the Ag/AgCl reference electrode 30 may be silver wire, which has been oxidized in sea water at +9 V for 10 sec to form a AgCl coating. This electrode was used as a solid state electrode in the sea water medium (I=0.7) so that no pressure effects on filling solutions would hinder electrode performance. Comparison of peak potentials for the analytes measured in situ and aboard ship was the same and similar to those for a saturated calomel electrode (SCE). The tubing leading into the flow cell's inlet (not shown) was placed in a sensor package, which was held over the vent orifice and areas along the length of vent chimneys. These latter areas are termed diffuse flow because water temperatures can range from 8 to 125° C. and do not emanate from the vent orifice; the cell sits in a basket at 2° C. A submersible electrochemical analyzer (DLK-sub I) from Analytical Instrument Systems, Inc. was used for data collection.

The electrodes are preferably made with wires that are set with a non conductive, high strength polymer such as epoxy within an inert tubing such as PEEK. These encapsulated electrodes are polished flat so that no portion of the sample stream can migrate up the wire and only the exposed cross section of the wire interacts with the sample fluid.

This cell structure, and particularly the electrode interface with the species being measured, provides the accuracy and reliability of measurement noted above over a wide range of pressures and temperatures. The diameter of wire used in the electrodes which interfaces with the species is preferably quite small as noted above. The small area of the polished face of the wire in contact with the species and placement of the wires in the cell facilitates a reading at the boundary layer (200-300 Angstroms) between the wire end and the species.

The small wire size and electrode placement also facilitates rapid conditioning of the electrode with an electrical charge. That conditioning is effectuated by sending an electric charge to the electrode which cleans off the electrode. Unlike many prior art cells, this conditioning can be done in situ in the cell of this invention. The small size and placement of the electrodes also helps to offset the effects of flow and pressure in deep water applications.

The volume of the flow cell is small and permits operation under enclosed conditions with no flow so that the respiration of single larval organisms or other controlled incubation studies can be followed over time. The flow cell can be made smaller or larger as required for these types of incubation studies.

Both laboratory and shipboard analyses may be carried out using an Analytical Instrument Systems (AIS) DLK-100 potentiostat controlled by a microcomputer using software provided by the manufacturer. Field sampling was performed using a Rabbit-Plus peristaltic pump (Rainin Instrument Co., Inc.) with a flow rate of 12 mL/min through Teflon® tubing. For natural water analysis from surface waters to 2500 meter water depth, the submersible analyzer was used for data collection. A general Oceanics T5 submersible pump was used to fill the cell; the cell could be used under flow conditions but was typically used under diffusion control conditions when the pump was turned off since hydrothermal vent waters may undergo rapid change.

Electrodes were calibrated at different temperatures and flow and scan rates.

### EXAMPLES

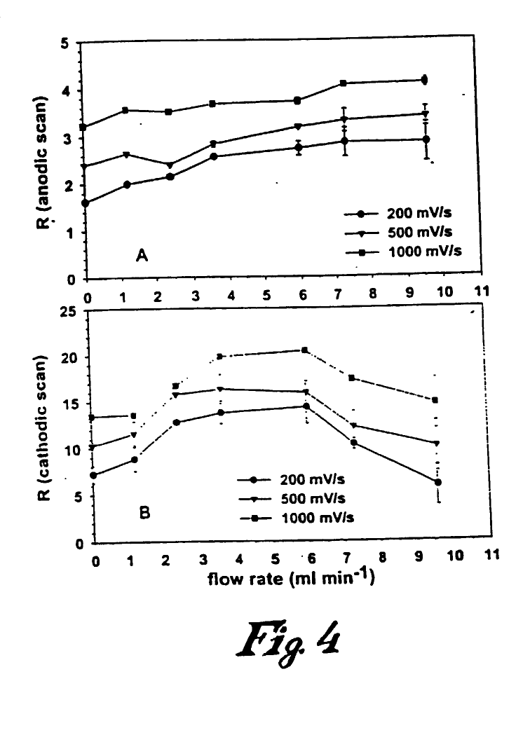

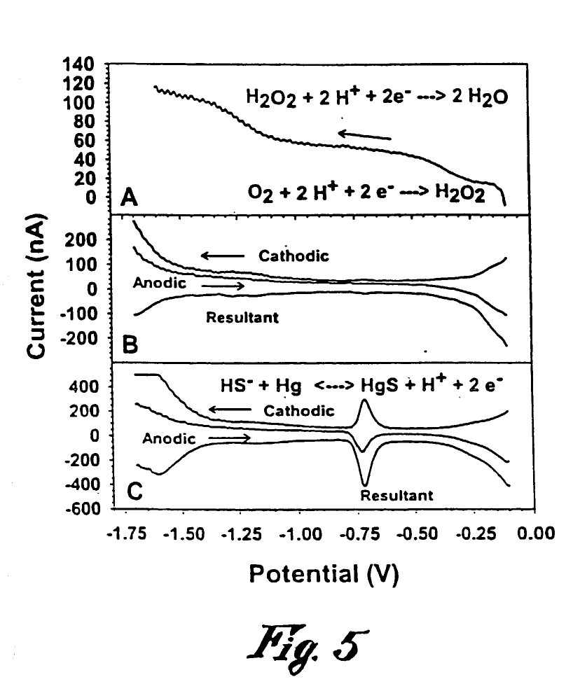

The three-electrode configuration was used to determine the concentration of the species present in natural waters. As is shown on FIGS. 4 and 5, linear sweep voltammetry (LSV), cyclic voltammetry (CV) and square wave voltammetry (SWV) were typically used for analyses. CV and SWV were used to test for reversibility. SWV is the method of choice for low level detection for a reversibility. LSV and CV were used for fast scans and when only O₂ was detectable. The following conditions were generally applied during the LSV scans: scan rate =200 to 1000 mV/s, scan range =−0.1 to −1.7 V, equilibrium time =5 s. Square wave voltammograms were conducted under the same conditions with a pulse height of 24 mV, 1 mV scan increment and 200 mV/s scan rate. To prevent memory effects, caused by the accumulation of sulfide and metal species on the mercury surface, conditioning steps were applied to the working electrode as per Brendel and Luther. Brendel, P.; Luther, III, G. W., Environ. Sci. Technol. 1995, 29, 751-761. To re-oxidize metals (Mn, Fe) that are reduced at the amalgam, a potential of −0.1 V was applied for 30 seconds before each scan. When sulfide was present, conditioning at −0.8 V for 10 s was employed since the metals and sulfide are not electroactive at that potential. All these conditions were typically applied in the lab, shipboard and in situ experiments.

The electrodes were first calibrated at zero flow with Mn(II) and then calibrated for S(−II) at different flow rates with the flow cell. A sensitivity ratio, R, was calculated via the expression as equation 2:

R=S^{f}_{S(-II)}/S^{f=0}_{Mn(II)} (2)

where S^{f=0}_{Mn(II)} is the sensitivity of Mn(II) at flow f=0 and S^{f}_{S(-II)} is the sensitivity of S(−II) at flow f. FIG. 4 presents the effect of the flow rate on the sensitivity ratio R by cathodic cyclic voltammetry (CSV, scan from −0.1 to −1.8 V with return to −0.1 V) at different flow rates. Calibrations for sulfides were determined by considering both positive wave (Chart A on FIG. 4) and the negative wave (Chart B on FIG. 4). The positive current wave is due to the formation of HgS and HgSₓ films at the electrode at positive potentials (Equation 3) and the reduction of the films to reform Hg on scanning negatively (Equation 4).

HS—+Hg→HgS+H—+2e− reaction more positive than −0.6 V (3)

HgS+H—+2e−⇄HS—+Hg at −0.6 V (4)

The negative wave is due to the reformation of the HgS and HgSₓ films at the electrode on scanning positively (reverse reaction of eq.4). This electrochemical reoxidation of Hg by sulfide is formally analogous to the reduction wave of Mn(II) at a Hg electrode.

In a complex aqueous system containing several sulfur species such as HS⁻, S(0), S²⁻ₓ, and FeS_{(aq)} at the pH of seawater, the positive wave (cathodic) will provide information on the sum of H₂S/HS⁻, S(0), and S²⁻ₓ only, while the negative wave (anodic) will account for total S(−II) which includes H₂S/HS⁻ and FeS_{(aq)}. Thus, a comparison of these two waves can be used to quantify FeS_{(aq)}.

For the cathodic wave B in FIG. 4, R is larger than the current for the anodic wave because of the pre-concentration effect. There is also an increase in R from diffusion control conditions at low flow rates with a plateau occurring near 2 mL/min. Because sulfide is reacting with the Hg film to form HgS during the scan, there is a decrease in R at high flow rates due to saturation of the Hg film with sulfide. This saturation effect is noticeable at about 600 μM free sulfide for the 100 μM Au/Hg electrode when scanning in this cathodic direction. Both Charts A and B on FIG. 4 demonstrate that R increases with scan rate, which is consistent with the well known dependence of I on (scan rate).

The waters of the Chesapeake Bay were sampled during the summer season when deep basin waters overlying the sediments become anoxic. The upper Bay is about 30 meters deep and the lower Bay is 20 meters deep due to the Potomac River depositing sediments to the lower Bay. This allows for entrainment of high salinity water during tidal motion and the formation of stagnant bottom waters in the upper Bay. These waters become sulfidic when oxygen is depleted and sulfate is used as the terminal electron acceptor for organic matter decomposition in the sediments and water column.

FIG. 5 presents voltammetric scans for the oxic (0.5 m; LSV), suboxic (no detectable O₂ and H₂S at 16 m; SWV) and sulfidic (19.5 m; SWV) waters, respectively. C at FIG. 5 shows that the cathodic scan plot has a higher current than that for the anodic scan plot because of the pre-concentration effect on starting the scan at positive potentials. This effect allows for low detection limits of free sulfide for this Au/Hg electrode, on the order of <0.1 μM.

Data from one profile (0-19 m) through the oxic, suboxic and into the anoxic sulfidic zone are shown in Table 1. There is marked similarity between oxygen concentrations determined via in situ CTD system, which uses a Clark-style amperometric O₂ sensor, as well as by Winkler-titration from a bottle cast, and the sampling by direct introduction into the voltammetric flow-cell using a peristaltic pump.

Precision for all methods is less than 2%.

Values for the concentration of O₂ are consistent with values obtained by the CTD array as well as by Winkler titrations, with apparent under-estimations for the Winkler values at 9 and 11 meter depths. The lower Winkler values resulted from scavenging of oxygen from the sample as the Niskin bottles sat for about an hour between sample collection and the addition of Winkler reagents for O₂. The need to sample and add the reagents immediately for O₂ using the Winkler method is well known. The low concentrations reported from the CTD O₂ sensor in the anoxic/sulfidic zone reflect the measurement of current at one fixed potential rather than a current vs. potential curve so that a true zero or residual current as shown by A in FIG. 5 cannot be determined. Detection limits for the Winkler titration and the Au/Hg electrodes are 5 and 3 micro-molar, respectively.

TABLE 1

| depth | O₂ | | O₂ | H₂S | H₂S |
|---|---|---|---|---|---|
| (m) | electrode | O₂ CTD | Winkler | electrode | HDME |
| 0.5 | 279.0 | 277.9 | 278.8 | ND | ND |
| 9 | 191.0 | 210.5 | 152.2 | ND | ND |
| 11 | 169.0 | 167.6 | 89.5 | ND | ND |
| 16 | ND | 1.43 | ND | 0.20 | 0.09 |
| 18 | ND | 1.16 | ND | 8.40 | 8.96 |
| 19 | ND | 1.12 | ND | 13.5 | NA |

ND = NOT DETECTED
NA = NOT ANALYZED

Sulfide concentrations determined by the flow cell were virtually identical to those obtained by HDME. Sulfide was first detected at trace levels (0.2 μM) at 16 meters and increased with depth to values as high as 14 μM at 19 meters. No overlap of H₂S and O₂ was in evidence in the profiles observed.

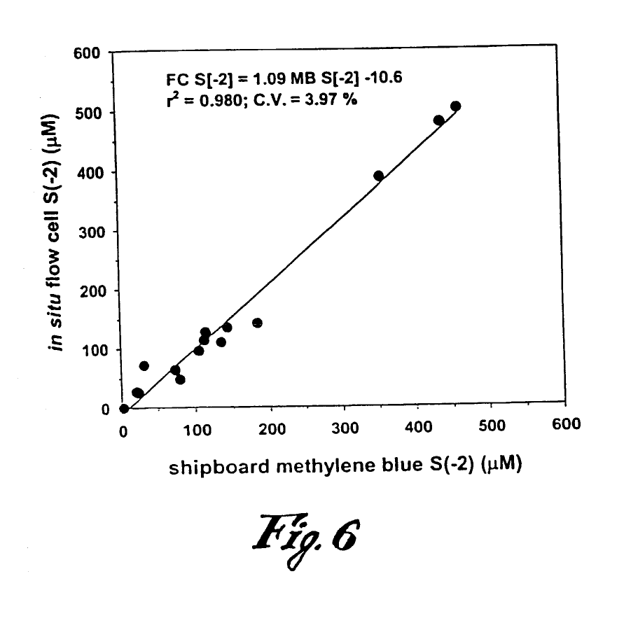

FIG. 6 shows real time data collected with the flow cell at a 2500 meter water depth from the submersible at 250 atm of pressure and which are compared to samples collected and measured aboard ship at atmospheric pressure. Agreement is very good for these samples that have little iron present to precipitate sulfide. However, samples that have high iron concentrations precipitate sulfide on ascent from 2400 m to the surface (time between sampling and measurement can be up to 6 hours). The real time data with the flow cell permit a better analysis than the traditional sampling method, which underestimates the actual value present in the sample. See Luther, III, G. W., Rozan, M. Taillefert, D. B. Nuzzio, D. Di Meo, T. M. Shank, R. A. Lutz, S. C. Cary. 2001. Chemical speciation drives hydrothermal vent ecology. Nature 410, 813-816.

The performance of the cell indicates that it is suitable for benchtop high-pressure work as well as deployment in high-pressure environments such as the deep ocean. The portability of the cell and its use in conjunction with a fully portable, DC-powered voltammetric analyzer facilitate its use in field applications that require remote sampling. The PEEK electrodes themselves are robust and have been successfully deployed from a remotely operated vehicle directly into near-shore sediments to the waters of the deep sea.

What is claimed is:

1. A method for in-situ electrochemical analysis under variable pressure, temperature and flow comprising:
a) introduction of a flow cell into the environment to be measured, said flow cell containing a central bore through the length thereof and having multiple holes radially extending from the central bore to the cylindrical surface with electrodes positioned in said holes and wiring attached to said electrodes.
b) Positioning said flow cell in the environment to be measured to enable flow of material to be measured through the central bore of the flow cell; and
c) Measurement of electrochemical properties of material passing through the central bore of the flow cell.

2. A flow cell for measurement of chemical species under variable pressure, temperature and flow conditions comprising a body of an inert polymer having a central bore along the length thereof with multiple holes radially extending from the central bore to the surface of the cylindrical body, and solid state electrodes with attached wiring positioned in the holes capable of measuring chemical species flowing through the central bore.

3. The flow cell of claim 2 wherein the material of the solid state electrode is selected from the group consisting of gold, gold amalgam, carbon or platinum.

4. The flow cell of claim 2 wherein the material for the cylindrical body of the flow cell is selected from the group consisting of polyethyletherketone, polytetraflouroethylene, polyethylene, polypropylene, polyether imide, polyvinylidene fluoride, and fluorinated ethylene propylene.

5. The flow cell of claim 3 wherein at least one of the solid state electrodes and attached wiring is encapsulated by a non-conductive high strength polymer within a surrounding inert polymer tubing and wherein the ends of the electrode are polished before insertion into the cell so that only the polished exposed surface of the electrodes are exposed to the chemical species to be measured.

6. The flow cell of claim 5 wherein the polished ends of the electrode have a maximum dimension of 200 micrometers.
